(19) United States
(12) Patent Application Publication
(10) Pub. No.: US 2014/0131385 A1
(43) Pub. Date: May 15, 2014

(54) BOTTOM LOADING WATER DISPENSERS WITH SLANTED BASE

(71) Applicants: George Yui, Toronto (CA); Alexander Sascha Yui, Toronto (CA)

(72) Inventors: George Yui, Toronto (CA); Alexander Sascha Yui, Toronto (CA)

(21) Appl. No.: 14/018,453

(22) Filed: Sep. 5, 2013

Related U.S. Application Data
(63) Continuation of application No. 13/177,521, filed on Jul. 6, 2011, now abandoned.
Application No. 13/177,521 is a continuation-in-part of application No. 12/416,781, filed on Apr. 1, 2009, now abandoned.

(51) Int. Cl. B67D 1/12

(52) U.S. Cl. CPC B67D 1/1247
USPC 222/66

(57) ABSTRACT

Bottom loading water dispensers are disclosed. The water dispensers include a cabinet having an exterior portion and an interior portion. The interior portion of the cabinet is configured to house a water bottle, in a bottom half of the cabinet. The dispensers also include a set of water dispensing actuator buttons, which include at least one child safety latch. The dispensers further include a bottle tray disposed in the bottom half of the interior portion of the cabinet, which is configured to receive a bottom surface of the water bottle in the upright position. Importantly, the bottle tray is slanted from a front side to a backside of the tray. A front door of the water dispensers also include a drip tray assembly, which is located beneath an external tap and is integrally formed with a top portion of a front door of the cabinet.

### CROSS-REFERENCE TO RELATED APPLICATIONS

This application is a continuation of U.S. patent application Ser. No. 13/177,521, filed Jul. 6, 2011, which is a continuation-in-part application of U.S. patent application Ser. No. 12/416,781, filed Apr. 1, 2009.

### FIELD OF THE INVENTION

The present invention relates generally to the field of bottled water dispensers and, more particularly, to bottom loading water dispensers.

### BACKGROUND OF THE INVENTION

The demand for clean and healthy drinking water is increasing dramatically, which is being driven by the rapid growth in population and standards of living across the globe. This demand has translated into a continuing need for safe, clean, and easy to use water dispensers, including for both hot and cold water. Many of the currently-available water dispensers are so-called “top loading” dispensers, which require a person to lift a heavy tank or bottle of water and secure it to the top portion of the dispensing device. This configuration often leads to muscle strain and injury—and, when not loaded properly, may damage the water dispensing device. In addition, the currently-available “bottom loading” dispensers are often unsatisfactory, insofar as the configuration of such dispensers often makes inserting a full (heavy) tank or bottle of water therein difficult and labor intensive.

As the following will demonstrate, many of the foregoing problems with currently-available water dispensers are addressed by the present invention.

### SUMMARY OF THE INVENTION

According to certain aspects of the invention, bottom loading water dispensers are provided. The water dispensers generally comprise a cabinet having an exterior portion and an interior portion, with the interior portion including a top half and a bottom half. The bottom loading water dispensers further include a water bottle that is disposed in the bottom half of the interior portion of the cabinet (in an upright position).

According to such aspects of the present invention, the dispensers also include a set of water dispensing actuator buttons, which include at least one child safety latch. The actuator buttons preferably include a top surface, which is parallel with a top surface of the water dispenser cabinet, which makes actuating the buttons (and dispensing water) user-friendly. The invention provides that the actuator buttons are configured to dispense water when the top surface thereof is pressed (forced) downwards.

Still further, according to such aspects of the present invention, the dispensers further include a bottle tray disposed in the bottom half of the interior portion of the cabinet, which is configured to receive the bottom surface of the water bottle in an upright position. Importantly, the bottle tray is slanted from a front side to a backside of the tray. This configuration facilitates the insertion of a full water bottle into the bottom half of the interior portion of the cabinet (in an upright position).

Additionally, a front door of the water dispensers may include a drip tray assembly. The drip tray assembly is located beneath an external tap of the water dispensers, and is integrally formed with a top portion of a front door of the cabinet. This configuration has been found to provide enhanced room to place a glass (or other container) beneath the external taps for receiving dispensed water, while simultaneously reducing the total height of the water dispenser (which is beneficial for shipping and retail storage purposes).

The above-mentioned and additional features of the present invention are further illustrated in the Detailed Description contained herein.

### BRIEF DESCRIPTION OF THE FIGURES

FIG. 1: A perspective view of a non-limiting example of a water dispenser described herein.

FIG. 2A: A top perspective view of an actuator button that includes a child safety latch.

FIG. 2B: A top perspective view of another actuator button that includes a child safety latch.

FIG. 3: A perspective view of one non-limiting example of a front panel.

FIG. 4: A perspective view of another non-limiting example of a front panel.

FIG. 5: A topside view of a bottle tray described herein.

FIG. 6: A front view of a front door of the water dispensers described herein, with a drip tray assembly located and integrally formed with a top portion of such front door.

FIG. 7: A diagram illustrating an exemplary arrangement of the flow sensor, filter, and pump described herein.

FIG. 8: A diagram illustrating another exemplary arrangement of the flow sensor, filter, and pump described herein.

FIG. 9: A diagram illustrating a reed-type flow sensor that may be used in the present invention.

FIG. 10: A cross-sectional view of a water dispenser of the present invention, showing a preferred location of an in-line water flow dispenser.

FIG. 11A: A diagram illustrating the path of water flow, in the flow sensor that is illustrated in FIG. 11B.

FIG. 11B: A diagram illustrating another type of flow sensor that may be used in the present invention, which utilizes two electrodes to detect the presence (and absence) of water flow.

FIG. 12: A diagram illustrating an alternative type of flow sensor that may be used in the present invention, which utilizes two electrodes to detect the presence (and absence) of water flow.

FIG. 13: A diagram illustrating a second alternative type of flow sensor that may be used in the present invention, which utilizes two electrodes to detect the presence (and absence) of water flow.

FIG. 14: A diagram illustrating a third alternative type of flow sensor that may be used in the present invention, which utilizes two electrodes to detect the presence (and absence) of water flow.

FIG. 15: A diagram illustrating a fourth alternative type of flow sensor that may be used in the present invention, which utilizes two electrodes to detect the presence (and absence) of water flow.

FIG. 16: A diagram illustrating an assembled view of multiple electrodes that may be used in the water dispenser of the present invention, which are used to detect and report to the control board the water level (volume) within the dispenser.

FIG. 17: A disassembled view of the multiple electrodes shown in FIG. 16.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

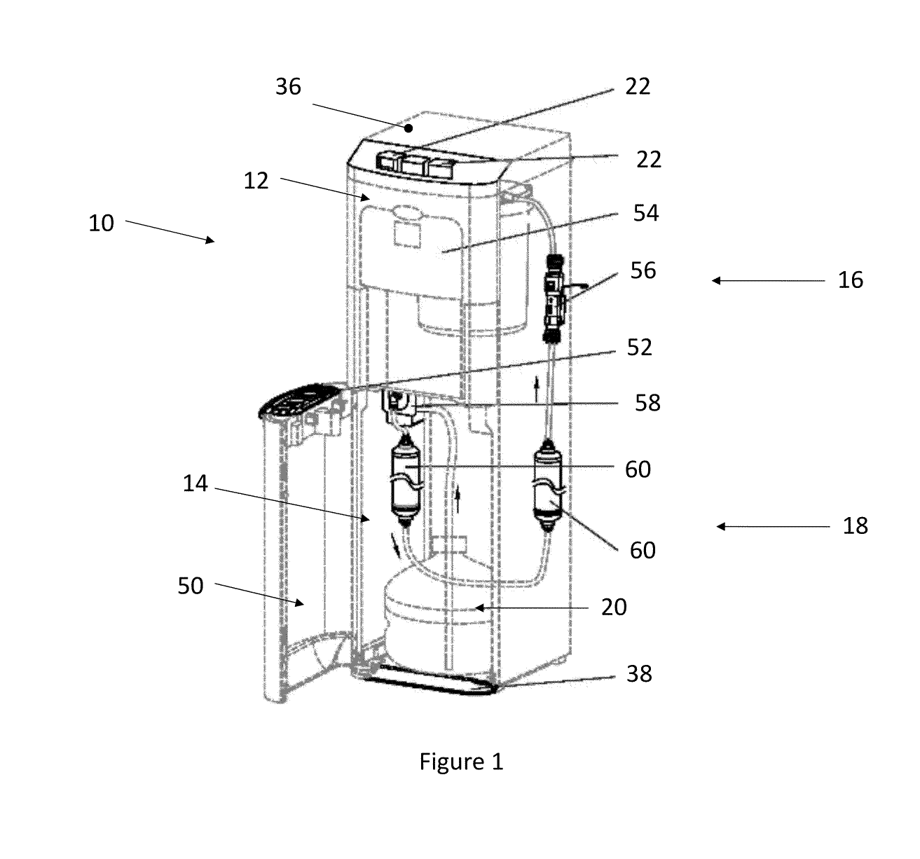

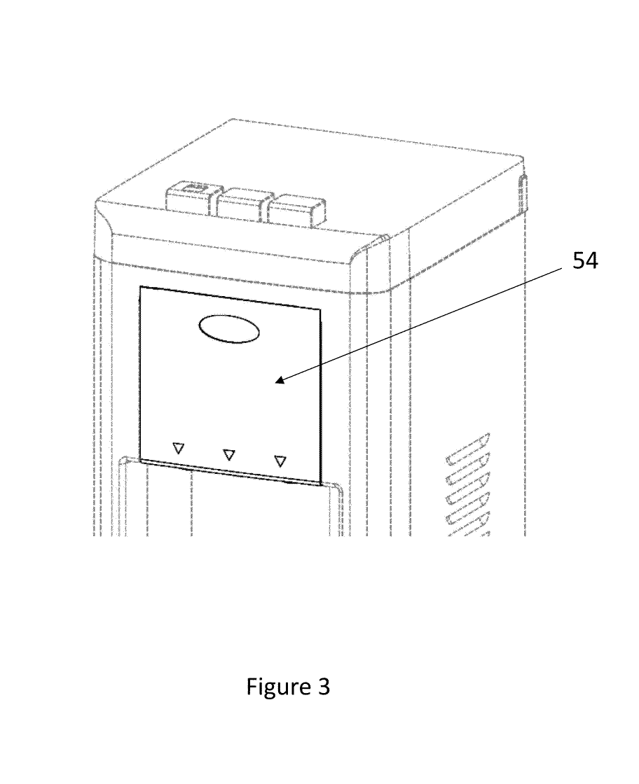

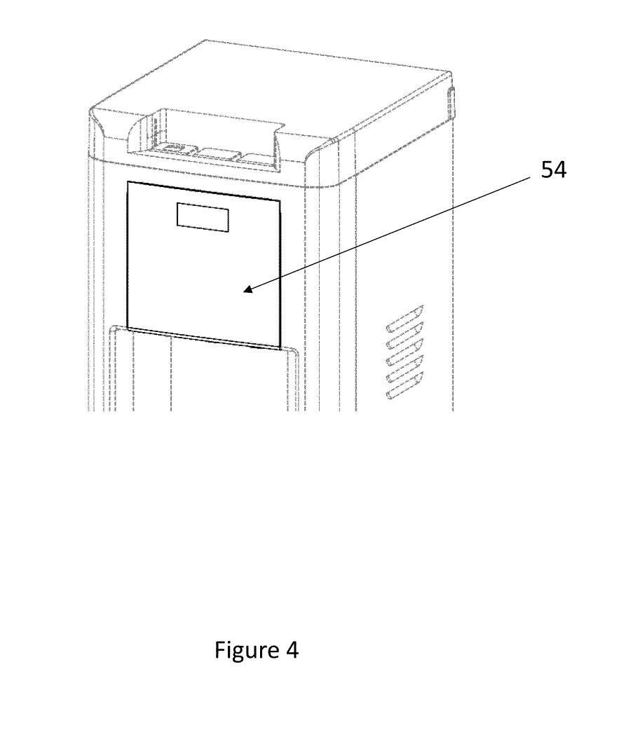

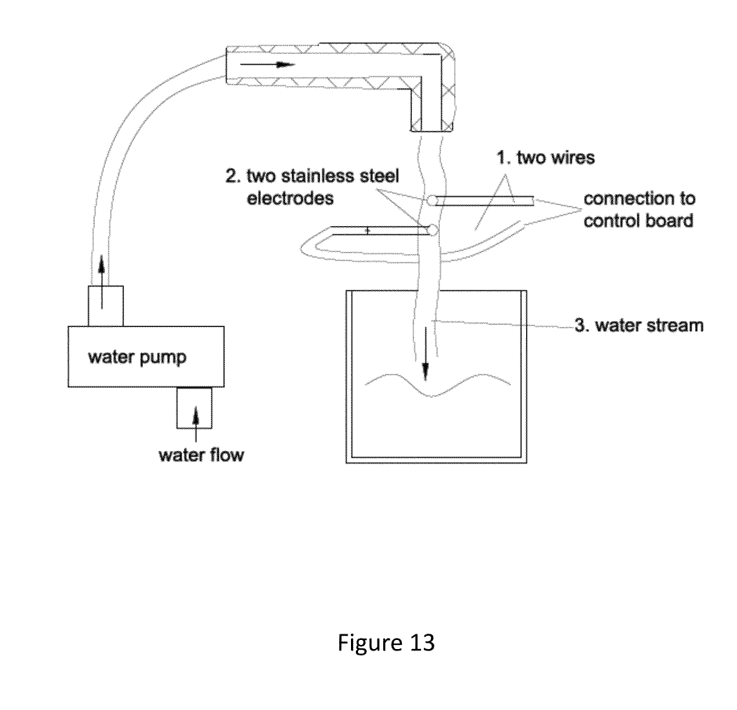

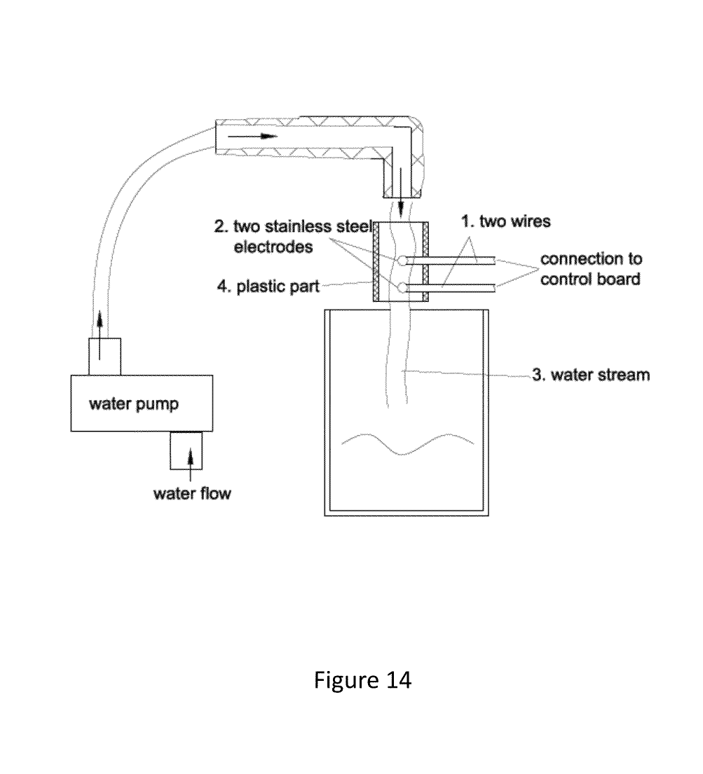

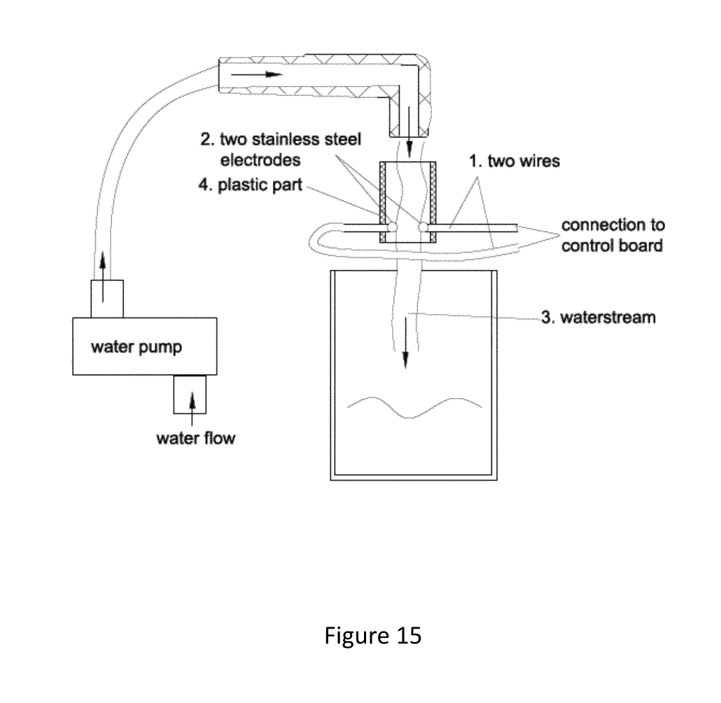

Referring now to FIGS. 1-15, according to certain preferred embodiments of the present invention, bottom loading water dispensers are provided 10. The water dispensers generally comprise a cabinet having an exterior portion 12 and an interior portion 14, with the interior portion 14 including a top half 16 and a bottom half 18. The bottom loading water dispensers further include a water bottle 20 that is disposed in the bottom half 18 of the interior portion 14 of the cabinet (in an upright position).

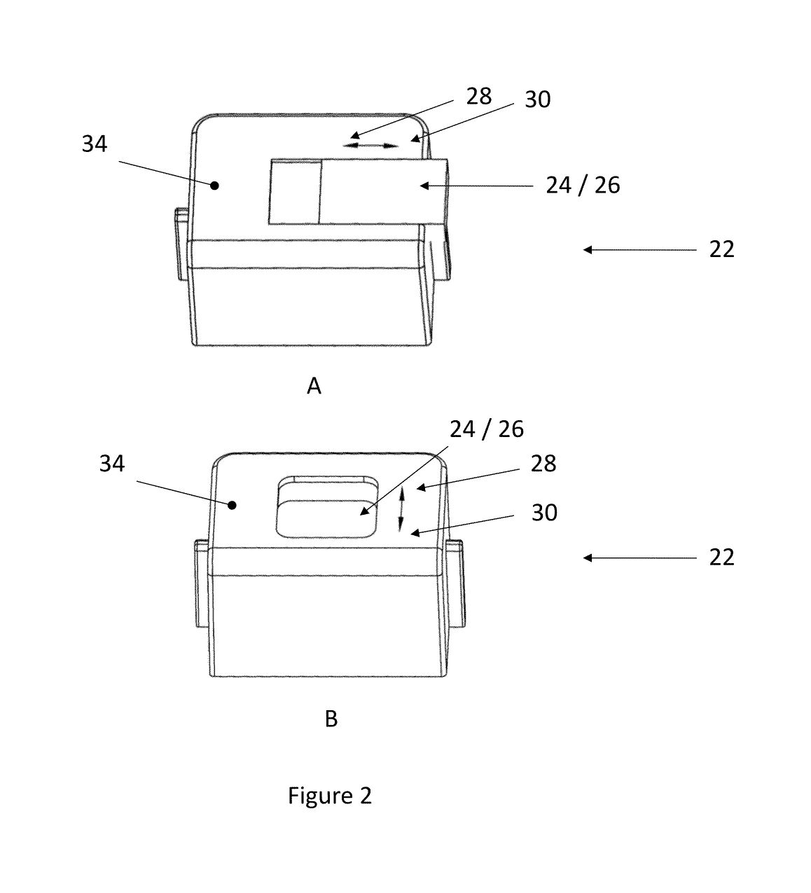

According to such aspects of the present invention, the dispensers also include a set of water dispensing actuator buttons 22, which include at least one child safety latch 24 (FIG. 2) in at least one of the buttons (such as the button that may be depressed to dispense hot water). The child safety latch 24 preferably comprises an element 26 that is configured to be moved in a first direction 28 (on the exterior surface of the actuator button 22), which allows the actuator button 22 to then be pushed downwards to cause water to be dispensed. When the child safety latch 24 is released (and the force that moved the element 26 in the first direction 28 is removed), an internal spring will force the element 26 back in a second direction 30, which prevents the actuator button 22 from being pushed downwards (thereby preventing water from being dispensed).

The child safety latch 24 preferably comprises a recessed area 32, which is configured to receive the element 26 when it is moved in the first direction 28. The invention provides that the child safety latch 24 may be located on the top surface, or front surface, of the actuator button 22. The actuator buttons 22 preferably include a top surface 34, which is parallel with a top surface 36 of the water dispenser cabinet. According to such design, the top surface 34 may be parallel and contiguous with the top surface 36 of the water dispenser cabinet—or, alternatively, the top surface 34 may be located above or below the top surface 36 of the water dispenser cabinet (while still being parallel thereto). The invention provides that the actuator buttons 22 are configured to dispense water when the top surface 34 thereof is pressed (forced) downwards. The actuator buttons 22 may be configured to dispense water, as described in U.S. Patent Application Publication 2010-0243683, which is hereby incorporated by reference in its entirety.

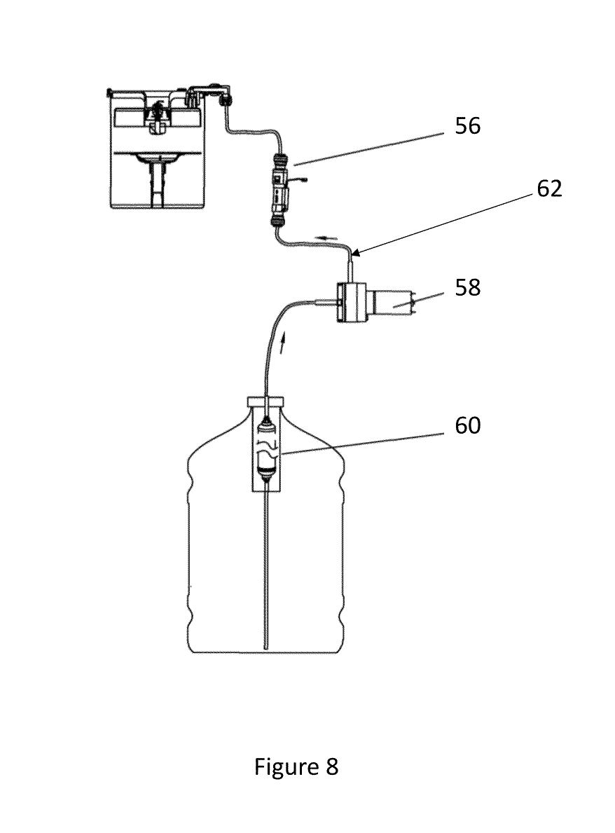

Still further, according to certain preferred embodiments of the present invention, the dispensers further include a bottle tray 38 disposed in the bottom half 18 of the interior portion 14 of the cabinet. The bottle tray 38 (FIGS. 1 and 8) is configured to receive the bottom surface of the water bottle 20 in an upright position. Importantly, the bottle tray 38 is slanted from a front side 40 to a backside 42 of the tray 38. That is, when facing the front of the water dispenser, i.e., the side on which the actuator buttons 22 are located, the bottle tray 38 is higher at the front side 40 thereof than the backside 42 of the tray 38. The degree of the slope of the slant may range, for example, from 0.1-5 degrees, 5-10 degrees, 10-20 degrees, or more. Described another way, the bottle tray 38 is slanted such that the front side 40 thereof is a further distance from a floor surface than the backside of the tray 42. This configuration facilitates the insertion of a full water bottle into the bottom half 18 of the interior portion of the cabinet (in an upright position).

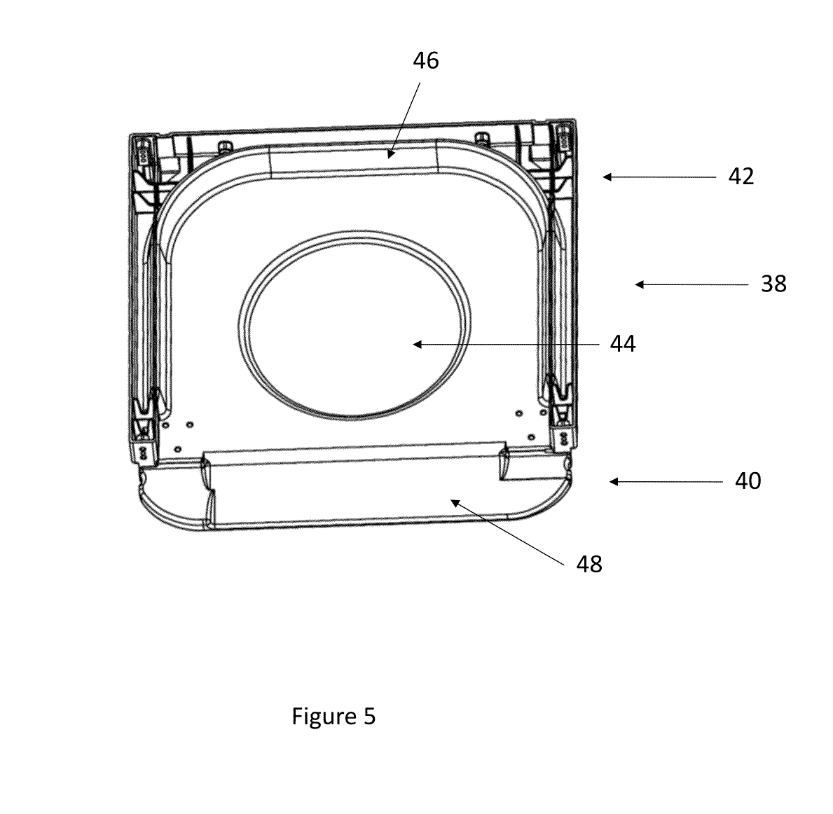

Referring to FIG. 5, the invention provides that the bottle tray 38 comprises a recessed area 44 that is configured to receive a bottom surface of the water bottle 20. The bottle tray 38 comprises a perimeter wall 46, which is configured to prevent the water bottle 20 from falling out of the cabinet, particularly when pressure may be injected into the water bottle to extract water therefrom. According to such embodiments, the bottle tray 38 may comprise a lip 48 that is configured to assist a user with inserting the water bottle 20 onto the bottle tray 38.

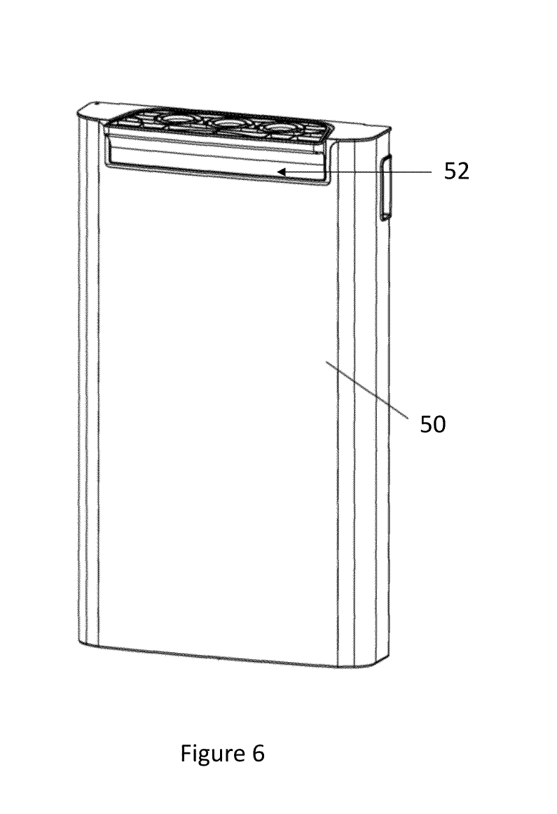

According to further embodiments of the present invention, the water dispensers include a front door 50 (FIG. 6) that includes a drip tray assembly 52. The drip tray assembly 52 is preferably built into the front door 50, such that it is located beneath an external tap of the water dispensers, and is integrally formed into the top portion of the front door 50 of the cabinet. This configuration has been found to increase the amount of room that is available to place a glass (or other container) beneath the external tap when receiving dispensed water, while simultaneously reducing the total height of the water dispenser (which is beneficial for shipping and retail storage purposes).

According to certain preferred embodiments, the invention provides that the water dispensers further include an upper front panel 54, which may be comprised of various materials, such as stainless steel, plastics, or other materials (and may, optionally, be painted with a desired color). The front panel 54 may also, optionally, exhibit a logo or other branding insignia.

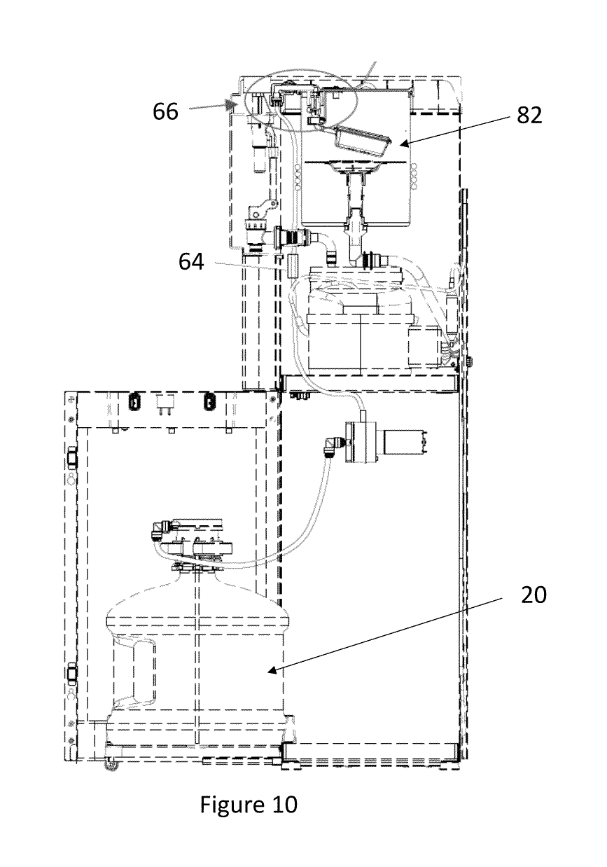

The water dispensers of the present invention further include a flow sensor 56, which causes the pump 58 to stop extracting water from the water bottle 20 when there is an insufficient amount of water in said water bottle, e.g., when water stops flowing through the flow tubes 62 from the water bottle 20. Referring to FIG. 10, the flow sensor 56 may be an in-line water flow sensor located at, or approximately at, position 64 (near the top of the cold water tank 82). However, more preferably, the flow sensor 56 may employ the use of a set of electrodes (at position 66) to detect the presence (or absence) of water flow, as described further below.

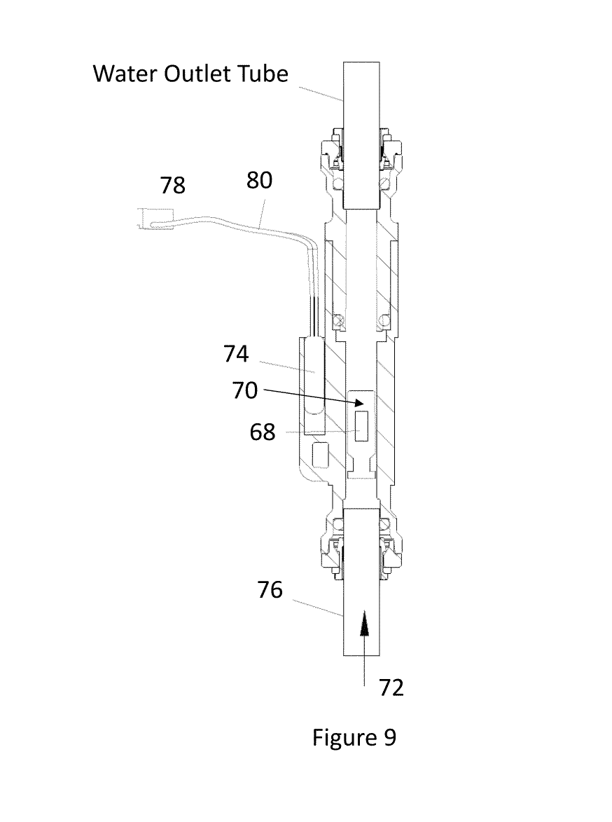

Referring now to FIG. 9, the invention provides that the flow sensor 56 may be a reed-type of flow sensor with a magnetic actuator 68, which is attached to a float 70 that travels in the direction of water flow 72 (through a water inlet tube 76), and will activate a reed switch 74 that is encapsulated in the outer housing of the flow sensor 56, when the magnetic actuator 68 is moved (by water flow) in sufficiently close proximity to the reed switch 74. The reed switch 74 will be in electrical communication (e.g., through a connected wire 80) with a control board 78, such that the control board 78 is notified upon activation of the reed switch 74, e.g., such that the control board 78 may then issue a signal to the pump 58. Alternatively, the invention provides that the magnetic actuator 68 may be replaced with a pair of electrodes (on the float 70), which detect absence of water by the absence of electrical conductivity between such electrodes (which, in turn, is communicated to the control board 78, which then instructs the pump 58 to shut down).

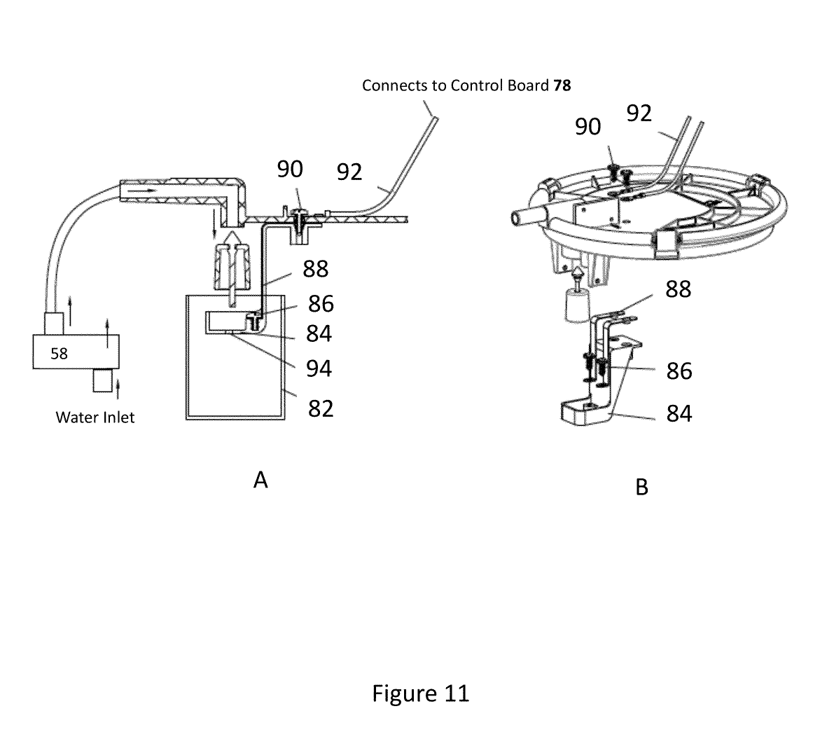

More preferably, however, referring now to FIG. 11 and to other embodiments of the invention, the flow sensor 56 will comprise a set of electrodes, in the path of water flow. According to such embodiment, the absence of water flow between such electrodes will cause an electrical short, which in turn causes a signal to be issued to the control board 78, which then issues a signal to shut down the pump 58. More particularly, and referring to FIG. 11, the flow sensor 56 assembly may include a storage box (or reservoir) 84 that is housed within the cold tank 82. The reservoir 84 includes a pair of electrodes secured thereto with a pair of screws 86. The pair of electrodes (which are immobilized in or near the reservoir 84), are in electrical communication through a pair of wires or other electrical transduction medium 88 with a second set of screws 90, wherein the second set of screws 90 provides a secure junction point at which the electrodes are able to transfer signals to a pair of wires 92, which are coupled to the control board 78. As mentioned below, the reservoir 84 may include a leak hole 94, through which water may slowly drain into the cold tank 82.

Still referring to FIG. 11, the invention provides that the pump 58 will cause water to flow from the water bottle 20 (FIGS. 1 and 10) and into a cold tank 82, prior to being extracted and dispensed from the external tap of the water dispenser. When sufficient water is present, the reservoir 84 will be filled with water, and the electrodes (secured by the pair of screws 86) will be immersed in water, such that an electrical current is allowed to flow between such electrodes. The electrical flow is communicated to the wires 92, by way of the wires or other electrical transduction medium 88. The wires 92 in turn communicate to the control board 78, which signals to the pump 58 that it may continue to operate and extract water from the water bottle 20.

When there is insufficient water in the water bottle 20, the pump 58 will be unable to adequately fill the cold tank 82 and, therefore, the reservoir 84. As such, in the absence of a sufficient amount of water in the reservoir 84, the electrical flow between the electrodes (at screws 86) is terminated. This lack of electrical flow is detected, via the wires or other electrical transduction medium 88, at the junction 90, such that the wires 92 signal to the control board 78 to shut down the pump 58. At this point, the control board 78 may also instruct a LCD screen (or other communication method, e.g., flashing lights, colored lights, etc.) on the water dispenser to communicate to a user that the water bottle 20 is empty.

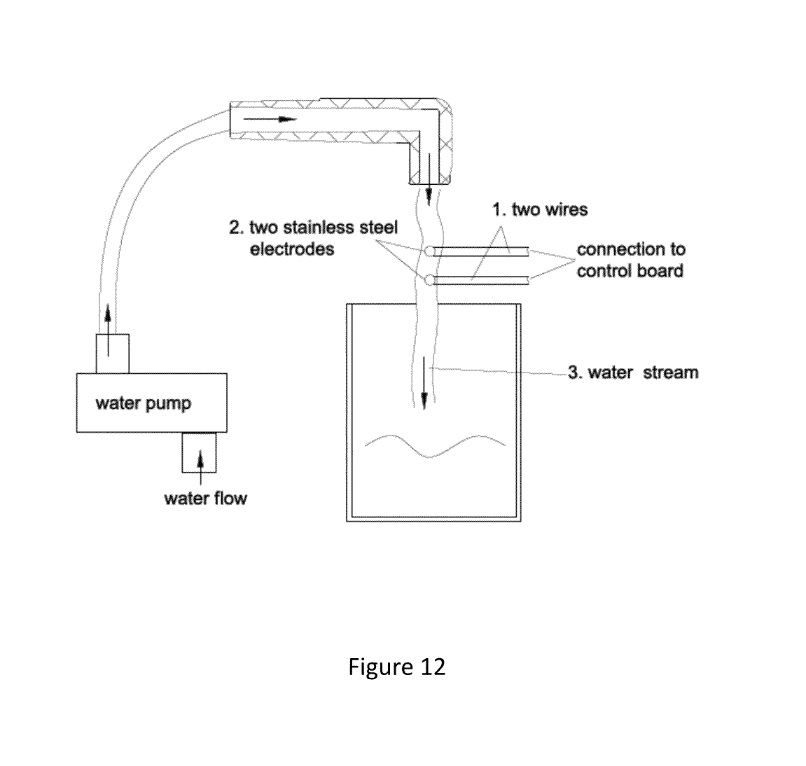

The invention provides that when the water bottle 20 is empty, and the cold tank 82 cannot be adequately filled, any residual water in the reservoir 84 will drain through the leak hole 94, to ensure that the lack of electrical flow between the electrodes 86 results—to signal to the control board 78 that the water bottle 20 is empty. The invention provides that the leak hole 94 will exhibit a smaller diameter than the diameter of the inlet through which water enters the cold tank 82. FIGS. 12-15 provide illustrations of other arrangements of a pair of electrodes, which may be used to detect the presence (or absence) of water flow in the water dispensers, in order to instruct the control board 78 when the pump 58 should be allowed to operate (and when it should be shut down when the water bottle 20 is empty).

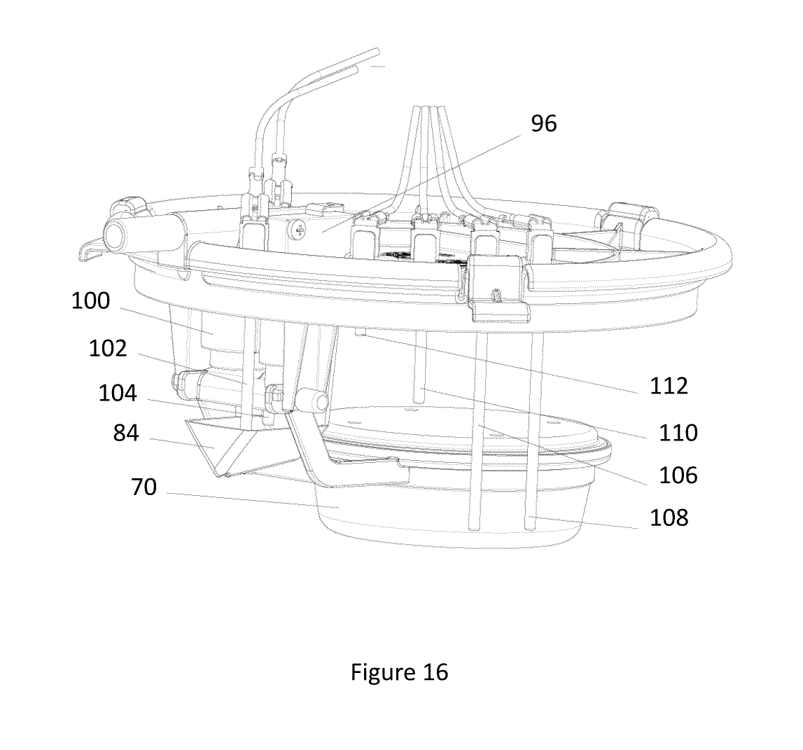

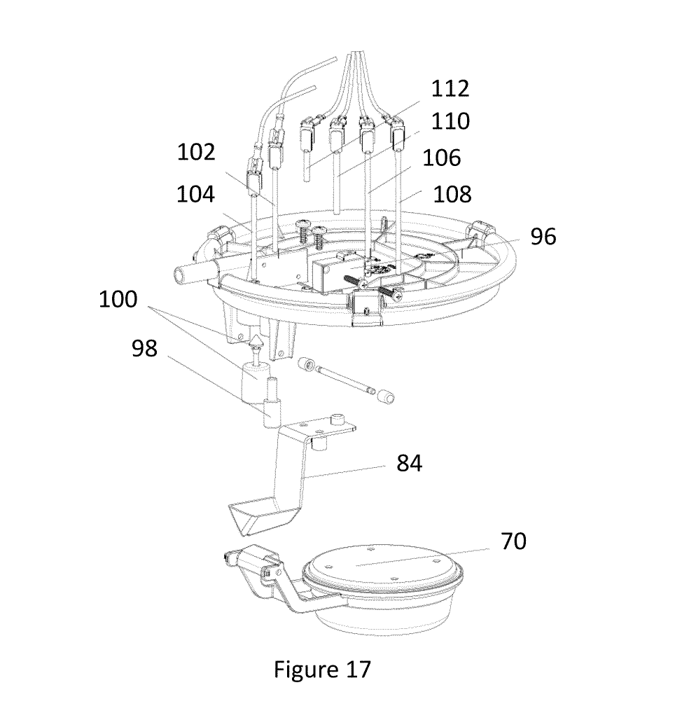

Referring now to FIG. 16, the invention provides that the water dispenser may utilize a micro-switch 96 to monitor and control water levels within the dispenser. More particularly, the invention provides that when the water level rises within the water dispenser, the float 70 rises with the water level about a hinge, which pushes into and activates an actuator micro-switch 98 (FIG. 17), which in turn activates the micro-switch 96, which then issues a signal to the control board 78 to shut down the pump 58. The invention provides that the micro-switch 96 feature, which may be used to control water levels, may be used as a replacement of the electrode-mediated methods of controlling water levels described herein. In other words, the invention provides that the micro-switch 96 may be used to control water levels within the water dispenser, or the electrode-mediated methods described herein, although both of such methods are not required.

Still further, the invention provides that the water dispenser may utilize a one-way valve 100, which is also operated by the mechanical float 70. More specifically, when the water level within the dispenser exceeds a certain volume threshold, the float 70 travels upwards along with the surface of the water, which causes the one-way valve 100 to close (and, when the water drops below such threshold, the float 70 lowers, which causes the one-way valve 100 to open and allows the passage of water). This one-way valve 100 feature is particularly useful to shut down the flow of water (when the volume exceeds a certain level), when there is an electrical (electrode) malfunction.

According to yet further embodiments of the invention, a plurality of electrodes may be used to monitor water levels, from low water levels to dangerously high levels of water. FIGS. 16 and 17 illustrate the location of the pair of electrodes 102/104 described above, which are positioned within or in close proximity to the reservoir 84. As explained above, when sufficient water is present in the reservoir 84, the electrodes 102/104 will be immersed in water, such that an electrical current is allowed to flow between such electrodes. The electrical flow is communicated to the control board 78, which signals to the pump 58 that it may continue to operate and extract water from the water bottle 20. When there is insufficient water in the water bottle 20, the pump 58 will be unable to adequately fill the cold tank 82 and, therefore, the reservoir 84. As such, in the absence of a sufficient amount of water in the reservoir 84, the electrical flow between the electrodes 102/104 is terminated. This lack of electrical flow is detected and signaled to the control board 78, which then shuts down the pump 58. Also as explained above, the invention provides that when the water bottle 20 is empty, and the cold tank 82 cannot be adequately filled, any residual water in the reservoir 84 will drain through the leak hole(s) 94 of the reservoir 84, to ensure that the lack of electrical flow between the electrodes 86 results—to signal to the control board 78 that the water bottle 20 is empty. The invention provides that the leak hole 94 will exhibit a smaller diameter than the diameter of the inlet through which water enters the cold tank 82, which also serves to stabilize water flow (in the event of unstable water flow into the cold tank 82).

In certain embodiments, additional electrodes 106, 108, 110, and 112 may be used to control water levels. According to such embodiments, the invention provides that electrodes 106 and 108 are of equal length. The invention provides that electrode 106 represents a first pole (cathode/anode), with electrodes 108, 110, and 112 representing the opposite pole of electrode 106. As such, the water level within the dispenser may be monitored via the detection of an electrical current flow between (1) electrode 108 and (2) electrodes 106, 110, and 112, and such electrical flow (or the absence thereof) may be communicated to the control board 78, which may then control the pump 58 and other features of the water dispenser. For example, the presence of an electrical current between electrodes 106 and 108 will indicate a low water level, which should cause the control board 78 to cause the pump 58 to be activated. The presence of an electrical current between electrodes 108 and 110 will indicate that the water level is at a desired height (volume), such that the pump 58 may be deactivated. The presence of an electrical current between electrodes 108 and 112 will indicate that the water level is dangerously high, which may cause the control board 78 to sound an alarm to alert users of the problem. As shown, electrodes 106, 110, and 112 increase in height (or become shorter relative to the top portion thereof), such that the water levels—from low levels to dangerously high levels—may be detected via the presence (or absence) of electrical flow between such electrodes.

The invention provides that a DC or AC current may be employed, for communicating among the electrodes described herein. Although a DC-based method would cost less to produce, the presence of a DC current between the electrodes will create an electrolytic process that, over time, may cause the electrodes to erode (and pollute the drinking water). Alternatively, and more preferably, an AC-based method is used, which will reduce the effect of such electrolytic process. According to such embodiments, an AC pulse signal is preferably generated, with a peak voltage of about five volts, and a low voltage of about zero volts. The invention provides that the duration of each five volt pulse is short, e.g., about 400 microseconds every one second. This creates an isoelectric type of insulation (no current flowing) between the electrodes for most of the time, and thereby mitigating the electrolytic process since there is no current flowing through the electrodes for most of the time. Accordingly, utilizing an AC current will further avoid the water pollution problem that results from using a DC current. Still further, an AC current exhibits greater penetration through clean water (whereas DC currents have better penetration when the water contains minerals or other particles to conduct the current).

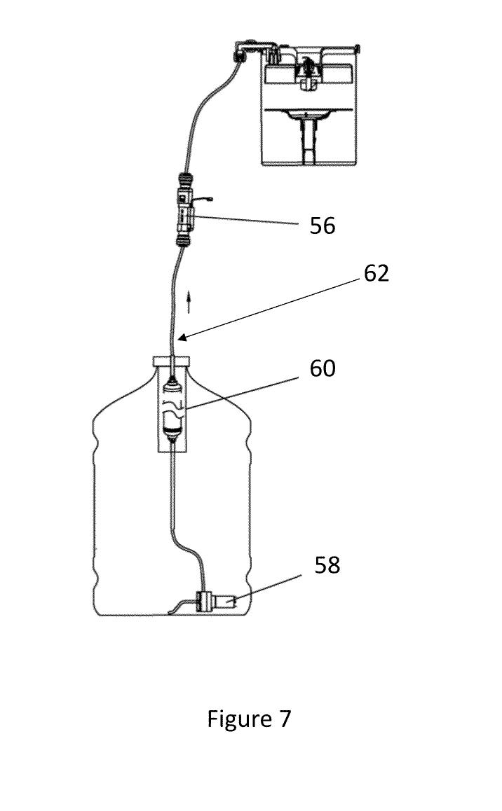

The invention provides that the pump 58 may be located inside the water bottle 20 (FIG. 7), to push water out of the water bottle 20, or outside of the water bottle 20 to pull water out of the water bottle 20 (FIGS. 1 and 8). The bottom loading water dispensers of the present invention further comprise one or more filters 60 operably connected to the one or more tubes 62. Non-limiting examples of such filters include carbon filters, sediment filters, alkaline filters, and combinations of the foregoing filters. Such filters 60 may be operably connected, in-line, with the tubes 62 as separate filters (e.g., FIG. 1) or as a single combination filter (e.g., FIG. 8).

The benefits of the foregoing bottom loading water dispensers include, for example, and among many others, the provision of an ergonomically improved method of loading and unloading water bottles into a water dispenser—which will avoid user injury and damage to the dispenser. The slanted bottle tray described herein, in addition to being a bottom loading water cooler, provides such ergonomic advantages.

The many aspects and benefits of the invention are apparent from the detailed description, and thus, it is intended for the following claims to cover all such aspects and benefits of the invention, which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottom loading water dispenser, which comprises:
(a) a cabinet having an exterior portion and an interior portion, wherein the interior portion of the cabinet is configured to house a water bottle in a bottom half of the interior portion of the cabinet in an upright position;
(b) a set of water dispensing actuator buttons, wherein (i) at least a first bottom comprises a child safety latch and (ii) at least a portion of a top surface of each actuator button is parallel with a top surface of the cabinet;
(c) a bottle tray disposed in the bottom half of the interior portion of the cabinet that is configured to receive a bottom surface of the water bottle in the upright position, wherein the bottle tray is slanted from a front side to a back side;
(d) a pump that is adapted to cause water to be extracted from the water bottle, through one or more tubes, and out of an external tap;
(e) a drip tray assembly, which is located beneath the external tap and is integrally formed with a top portion of a front door of the cabinet; and
(f) a flow sensor, which causes the pump to stop extracting water from the water bottle when there is an insufficient amount of water in said water bottle.

2. The bottom loading water dispenser of claim 1, wherein the bottle tray comprises a recessed area that is configured to receive a bottom surface of the water bottle.

3. The bottom loading water dispenser of claim 2, wherein the bottle tray comprises a perimeter wall.

4. The bottom loading water dispenser of claim 3, wherein the bottle tray comprises a lip that is configured to assist a user with inserting the water bottle onto the bottle tray.

5. The bottom loading water dispenser of claim 4, wherein the flow sensor comprises (i) a magnetic actuator that is affixed to a float which moves in a direction of water flow and (ii) a reed switch that is electrically coupled to a control board, wherein upon the magnetic actuator being moved in close proximity to the reed switch, an electrical signal is issued to the control board, which in turn issues a signal to the pump to terminate or continue extracting water from the water bottle.

6. The bottom loading water dispenser of claim 4, wherein the flow sensor comprises a pair of electrodes in the path of water flow, between the water bottle and the external tap, wherein in the presence of water, an electrical current flows between the electrodes, wherein said electrical flow is detected by a control board, which then signals to the pump that the water bottle contains a sufficient volume of water to continue extracting water therefrom.

7. The bottom loading water dispenser of claim 6, wherein in the absence of water between the pair of electrodes, an electrical current does not flow between the electrodes, wherein an absence of such electrical flow is detected by the control board, which then signals to the pump that the water bottle contains a insufficient volume of water and causes the pump to shut down.

8. The bottom loading water dispenser of claim 7, wherein the pair of electrodes is located at a position between the cold tank and the external tap.

9. The bottom loading water dispenser of claim 7, wherein the pair of electrodes is located in a reservoir, wherein the reservoir is located within or near the cold tank.

10. The bottom loading water dispenser of claim 9, wherein the reservoir comprises a leak hole from which water is allowed to drain from the reservoir.

11. The bottom loading water dispenser of claim 5, which further comprises one or more filters operably connected to the one or more tubes, wherein said filters are selected from the group consisting of a carbon filter, sediment filter, alkaline filter, and a combination of the foregoing filters.

12. The bottom loading water dispenser of claim 6, wherein the filters consist of a separate carbon filter and sediment filter.
